(19) United States
(12) Patent Application Publication
(10) Pub. No.: US 2026/0053165 A1
(43) Pub. Date: Feb. 26, 2026

(54) COLD BEVERAGE MAKER CAPABLE OF MEASURING TEMPERATURE OF MATERIAL

(71) Applicant: Guangdong Welly Electrical Appliances Co., Ltd., Zhongshan (CN)

(72) Inventors: Xiangan Wu, Zhongshan (CN); Quan Zhou, Zhongshan (CN)

(21) Appl. No.: 19/079,416

(22) Filed: Mar. 13, 2025

(30) Foreign Application Priority Data
Aug. 20, 2024 (CN) 202422023774.8

(51) Int. Cl. A23G 9/22; B01F 27/112; B01F 27/191; B01F 27/70; B01F 101/13

(52) U.S. Cl. CPC A23G 9/228; A23G 9/224; B01F 27/112; B01F 27/191; B01F 27/70; B01F 2101/13

(57) ABSTRACT

The present disclosure provides a cold beverage maker capable of measuring a temperature of a material, including an electrical control assembly, a refrigerating assembly, a stirring assembly, a feed assembly, and a discharge assembly, and further including a temperature sensor, where the temperature sensor includes a sensing end and a connecting end; the sensing end is provided in a refrigerating cylinder; and the sensing end is flush with an inner wall of the refrigerating cylinder. The sensing end is designed as an arc-shaped surface, with a radian matching with a radian of the inner wall of the refrigerating cylinder. After the temperature sensor is mounted, the sensing end can be flush with the inner wall of the refrigerating cylinder. The present disclosure ensures that the temperature sensor does not affect normal operation of other devices or processes, while contacting the material.

### CROSS REFERENCE TO RELATED APPLICATIONS

The present application claims the benefit of Chinese Patent Application No. 2024220237748 filed on Aug. 20, 2024, the contents of which are incorporated herein by reference in their entirety.

### TECHNICAL FIELD

The present disclosure relates to the technical field of cold beverage makers, and in particular to a cold beverage maker capable of measuring a temperature of a material.

### BACKGROUND

Ice cream and smoothie are one of cold beverage foods, and are very popular to adults and children in hot summer. To make the ice cream, cold beverage makers are used generally. The cold beverage makers are also referred to as ice cream freezers, and are automatic devices for producing frozen desserts, namely ice cream. According to the uses, the cold beverage makers can be classified into large-scale freezers for the factory line and commercial cold beverage makers for the catering industry.

The general household cold beverage maker has a simple structure. A temperature sensor is usually provided outside a refrigerating cylinder. Since the outside of the refrigerating cylinder is connected to a heat exchange tube for freezing, the temperature detected by the temperature sensor is different from the temperature of the material in the refrigerating cylinder. Therefore, the temperature of the milk cannot be known accurately, and the ice cream made is a liquid sometimes.

### SUMMARY

In view of the above defect, an objective of the present disclosure provides a cold beverage maker capable of measuring a temperature of a material, to solve the problem that the temperature sensor cannot directly feed the temperature of the material back.

In order to achieve the above objective, the present disclosure adopts the following technical solutions: The present disclosure provides a cold beverage maker capable of measuring a temperature of a material, including:
an electrical control assembly electrically connected to a refrigerating assembly and a stirring assembly, and configured to control a working state of the refrigerating assembly and a working state of the stirring assembly, or display a temperature of the material in a refrigerating cylinder;
a feed assembly communicating with the refrigerating cylinder, and configured to convey the material to the refrigerating cylinder;
the refrigerating assembly configured to refrigerate the refrigerating cylinder;
the stirring assembly configured to stir the material in the refrigerating cylinder to form a finished product and push the finished product to a discharge assembly; and
the discharge assembly configured to discharge the finished product in the refrigerating cylinder, where
the cold beverage maker capable of measuring a temperature of a material further includes a temperature sensor; the temperature sensor includes a sensing end and a connecting end; the sensing end is provided in the refrigerating cylinder; and the sensing end is flush with an inner wall of the refrigerating cylinder; and
the connecting end is provided outside the refrigerating cylinder; and the connecting end is electrically connected to the electrical control assembly.

Preferably, there are at least two temperature sensors, including a first temperature sensor and a second temperature sensor; the first temperature sensor is provided close to the discharge assembly; and the second temperature sensor is provided close to the feed assembly; and
both the first temperature sensor and the second temperature sensor are electrically connected to the refrigerating assembly; and the first temperature sensor is further electrically connected to the electrical control assembly.

Preferably, both the first temperature sensor and the second temperature sensor are electrically connected to the stirring assembly.

Preferably, with a central axis of the refrigerating cylinder as a standard line, a horizontal height of the second temperature sensor is not greater than a horizontal height of the standard line.

Preferably, the stirring assembly includes a power output component, a transmission rod, and a stirring paddle; the power output component is provided at one side of a housing; the transmission rod includes one end provided in the refrigerating cylinder through a bearing, and the other end connected to the power output component; a plurality of stirring paddles are equidistantly provided on a surface of the transmission rod; and the transmission rod is located at a central axis of the refrigerating cylinder.

Preferably, the refrigerating assembly includes a condenser, an evaporator tray, a compressor, and a heat exchange tube; and
one end of the heat exchange tube is connected to an inlet of the compressor; an outlet of the compressor is connected to an inlet of the condenser; an outlet of the condenser is connected to an inlet of the evaporator tray; and an outlet of the evaporator tray is connected to the other end of the heat exchange tube.

Preferably, the cold beverage maker capable of measuring a temperature of a material further includes a loading tray; and the loading tray is located under the discharge assembly.

Any one of the above technical solutions has the following advantages or beneficial effects: If the sensing end of the temperature sensor is protruded from the inner wall of the refrigerating cylinder, it is scraped by the stirring paddle possibly to cause damage to the temperature sensor. If the sensing end of the temperature sensor is recessed in the inner wall of the refrigerating cylinder, a part of the material will remain at the sensing end to increase the cleaning difficulty of the cold beverage maker. In the present disclosure, the sensing end is designed as an arc-shaped surface, with a radian matching with a radian of the inner wall of the refrigerating cylinder. After the temperature sensor is mounted, the sensing end can be flush with the inner wall of the refrigerating cylinder. This ensures that the temperature sensor does not affect normal operation of other devices or processes, while contacting the material.

### BRIEF DESCRIPTION OF THE DRAWINGS

FIG. 1 is a schematic structural view according to an embodiment of the present disclosure;

FIG. 2 is a structural sectional view according to an embodiment of the present disclosure; and

FIG. 3 is a schematic structural view of a temperature sensor according to an embodiment of the present disclosure.

In the figures: 1: housing, 2: refrigerating assembly, 2a: condenser, 2b: evaporator tray, 2c: compressor, and 2d: heat exchange tube;
3: stirring assembly, 3a: power output component, 3b: transmission rod, and 3c: stirring paddle;
4: discharge assembly, and 5: refrigerating cylinder;
6: temperature sensor, 6a: sensing end, 6b: connecting end, 6c: first temperature sensor, and 6d: second temperature sensor; and
7: feed assembly, 8: loading tray, and 9: electrical control assembly.

### DETAILED DESCRIPTION

The embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary, are used only for explaining the present disclosure, and should not be construed as a limitation to the present disclosure.

It should be understood that, in the description of the present disclosure, the terms such as “central”, “longitudinal”, “transverse”, “length”, “width”, “thickness”, “upper”, “lower”, “left”, “right”, “vertical”, “horizontal”, “top”, “bottom”, “inner”, “outer”, “axial”, “radial”, and “circumferential” are intended to indicate orientations shown in the drawings. It should be noted that these terms are merely intended to facilitate a simple description of the present disclosure, rather than to indicate or imply that the mentioned apparatus or element must have the specific orientation or be constructed and operated in the specific orientation. Therefore, these terms may not be construed as a limitation to the present disclosure.

In addition, the terms “first” and “second” are merely intended for a purpose of description, and shall not be understood as an indication or implication of relative importance or implicit indication of a quantity of indicated technical features. Thus, features defined with “first” and “second” may explicitly or implicitly include one or more of the features. In the description of the present disclosure, unless otherwise specified, “a plurality of” means at least two.

In the description of the present application, it should be understood that, unless otherwise specified and defined, the terms “mounted”, “connected with”, “connected to” should be comprehended in a broad sense. For example, these terms may be comprehended as being fixedly connected, detachably connected or integrally connected; or directly connected or indirectly connected through an intermediate medium, or in an internal communication between two elements. Those of ordinary skill in the art may understand specific meanings of the above terms in the present disclosure based on a specific situation.

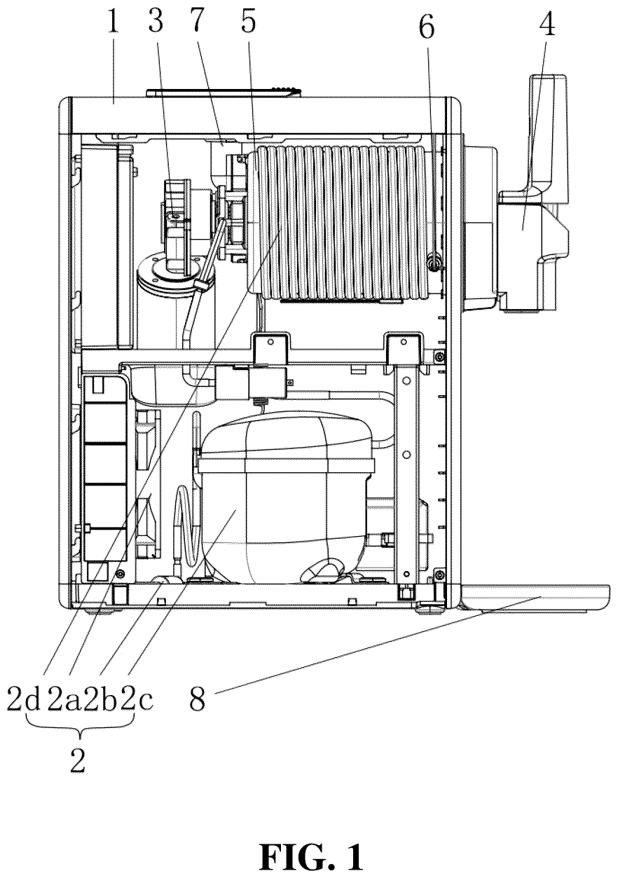

As shown in FIGS. 1-3, a cold beverage maker capable of measuring a temperature of a material includes:
an electrical control assembly electrically connected to a refrigerating assembly (2) and a stirring assembly (3), and configured to control a working state of the refrigerating assembly (2) and a working state of the stirring assembly (3), or display a temperature of a material in a refrigerating cylinder;
a feed assembly (7) communicating with the refrigerating cylinder (5), and configured to convey the material to the refrigerating cylinder;
the refrigerating assembly (2) configured to refrigerate the refrigerating cylinder (5);
the stirring assembly (3) configured to stir the material in the refrigerating cylinder (5) to form a finished product and push the finished product to a discharge assembly (4); and
the discharge assembly (4) configured to discharge the finished product in the refrigerating cylinder.

The cold beverage maker capable of measuring a temperature of a material further includes a temperature sensor (6). The temperature sensor (6) includes a sensing end (6a) and a connecting end (6b). The sensing end (6a) is provided in the refrigerating cylinder (5). The sensing end (6a) is flush with an inner wall of the refrigerating cylinder (5).

The connecting end (6b) is provided outside the refrigerating cylinder (5). The connecting end (6b) is electrically connected to the electrical control assembly.

One end of a housing (1) is provided with the electrical control assembly (9) and a feed inlet. The feed inlet communicates with the refrigerating cylinder (5) through the feed assembly (7).

The refrigerating assembly (2), the stirring assembly (3) and the refrigerating cylinder (5) are provided in the housing (1).

The refrigerating assembly (2) is provided with a heat exchange tube (2d). The heat exchange tube (2d) is wound on a surface of the refrigerating cylinder (5).

The stirring assembly (3) is provided at one side of the housing (1). The stirring assembly (3) is extended with a stirring paddle (3c). The stirring paddle (3c) is provided in the refrigerating cylinder (5).

The discharge assembly (4) is provided at the other side of the housing (1). The discharge assembly (4) is connected to one end of the refrigerating cylinder (5).

In the present disclosure, milk is poured through the feed inlet. The milk enters the refrigerating cylinder (5) through the feed assembly (7). After the refrigerating assembly (2) is started, the refrigerating cylinder (5) is cooled through the heat exchange tube (2d) to reduce a temperature of the milk in the refrigerating cylinder (5). In a freezing process of the milk, the milk is stirred by the stirring assembly (3). This can charge more air to the milk in crystallization, and makes ice cream softer and more palatable. When the milk reaches a certain temperature, pulling the discharge assembly (4) can output the ice cream.

In order to detect the temperature of the milk better in the present disclosure, a through hole is formed in the refrigerating cylinder (5). The temperature sensor (6) is provided in the through hole. The sensing end (6a) of the temperature sensor (6) is provided in the refrigerating cylinder (5), and can come in direct contact with the milk to obtain the temperature of the material more accurately. The electrical control assembly (9) may be a display screen with a control chip. The connecting end (6b) of the temperature sensor (6) is connected to the electrical control assembly (9) through a circuit. The detected temperature of the material can be directly fed back to the electrical control assembly (9). According to a temperature displayed on the electrical control assembly (9), whether the milk is frozen into the ice cream can be determined. Meanwhile, a power of the refrigerating assembly (2) and a power of the stirring assembly (3) can be adjusted by touching the display screen.

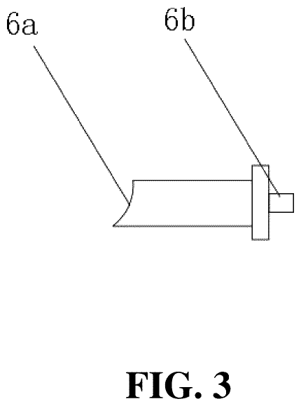

Besides, the stirring paddle is provided in the freeing cylinder (5). If the sensing end (6a) of the temperature sensor (6) is protruded from the inner wall of the refrigerating cylinder (5), it is scraped by the stirring paddle (3c) possibly to cause damage to the temperature sensor (6). If the sensing end (6a) of the temperature sensor (6) is recessed in the inner wall of the refrigerating cylinder (5), a part of the material will remain at the sensing end (6a) to increase the cleaning difficulty of the cold beverage maker. As shown in FIG. 3, in the present disclosure, the sensing end (6a) is designed as an arc-shaped surface, with a radian matching with a radian of the inner wall of the refrigerating cylinder (5). After the temperature sensor (6) is mounted, the sensing end (6a) can be flush with the inner wall of the refrigerating cylinder (5). This ensures that the temperature sensor (6) does not affect normal operation of other devices or processes, while contacting the material.

Preferably, the temperature sensor (6) is provided close to the discharge assembly (4).

The milk continuously stirred by the stirring paddle is pushed forward, and then stacked to an end of the refrigerating cylinder (5) close to the discharge assembly (4). The temperature detection is basically intended to detect whether the milk reaches a temperature for forming the ice cream. When the ice cream is squeezed by the discharge assembly (4), the milk at this position is squeezed. As long as the milk at this position is maintained at a crystallization temperature, the ice cream can be squeezed by the discharge assembly (4). If the temperature sensor (6) is close to the stirring assembly (3), new milk may be added when the temperature sensor (6) detects the temperature of the material. Even though the milk at the front end is crystallized into the ice cream, the temperature detected by the temperature sensor (6) still does not reach the crystallization temperature of the milk to prolong waiting time of the user.

Preferably, there are at least two temperature sensors (6), including a first temperature sensor (6c) and a second temperature sensor (6d). The first temperature sensor (6c) is provided close to the discharge assembly (4). The second temperature sensor (6d) is provided close to the feed assembly (7).

Both the first temperature sensor (6c) and the second temperature sensor (6d) are electrically connected to the refrigerating assembly (2). The first temperature sensor (6c) is further electrically connected to the electrical control assembly (9).

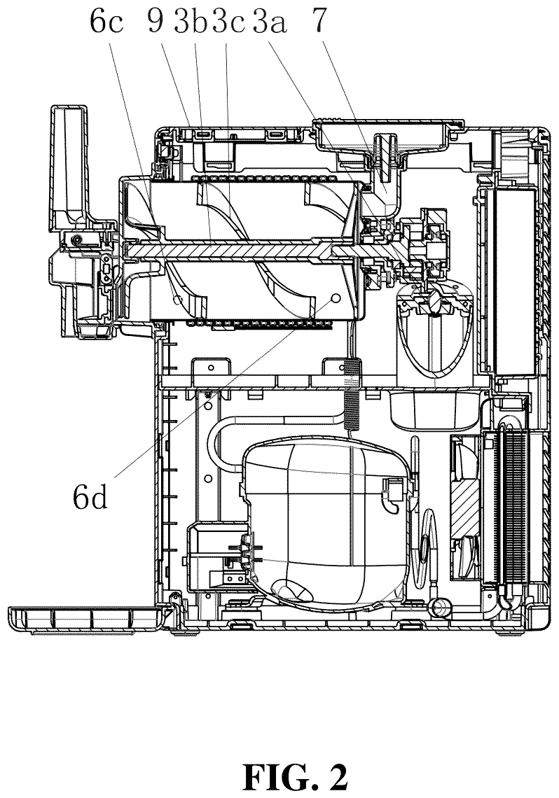

As shown in FIG. 2, in an embodiment of the present disclosure, there are a plurality of temperature sensors (6). The plurality of temperature sensors (6) are configured to determine temperatures at different regions of the refrigerating cylinder (5) to better control the refrigerating assembly. For example, normally, a temperature detected by the first temperature sensor (6c) is the same as a temperature detected by the second temperature sensor (6d). In this case, the refrigerating assembly (2) can be controlled to keep the crystallization temperature of the milk. When new milk is added, the temperature detected by the second temperature sensor (6d) is less than the temperature detected by the first temperature sensor. In order to accelerate crystallization of the milk, the power of the refrigerating assembly (2) can be increased to form the ice cream more quickly. When the temperature detected by the first temperature sensor (6c) is approximately the same as the temperature detected by the second temperature sensor (6d), the power of the refrigerating assembly (2) is readjusted.

Preferably, both the first temperature sensor (6c) and the second temperature sensor (6d) are electrically connected to the stirring assembly (3).

When new milk is added, the temperature detected by second temperature sensor (6d) is less than the temperature detected by the first temperature sensor (6c). In order to accelerate crystallization of the milk, the stirring assembly (3) can increase its power according to a different between the temperature detected by the first temperature sensor (6c) and the temperature detected by second temperature sensor (6d). Under an action of inertia, a part of milk is thrown to the inner wall of the refrigerating cylinder (5) to increase a contact area between the milk and the inner wall of the refrigerating cylinder (5), thereby improving heat exchange efficiency of the milk, and forming the ice cream more quickly.

Preferably, with a central axis of the refrigerating cylinder (5) as a standard line, a horizontal height of the second temperature sensor (6d) is not greater than a horizontal height of the standard line.

The second temperature sensor (6d) mainly functions to detect the temperature of the newly added milk. If the position of the second temperature sensor (6d) is overhigh, and an amount of the newly added milk is small, the second temperature sensor (6d) cannot contact the newly added milk to get a new temperature feedback.

Preferably, the stirring assembly (3) includes a power output component (3a), a transmission rod (3b), and a stirring paddle (3c). The power output component (3a) is provided at one side of the housing (1). The transmission rod (3b) includes one end provided in the refrigerating cylinder (5) through a bearing, and the other end connected to the power output component (3a). A plurality of stirring paddles are equidistantly provided on a surface of the transmission rod (3b). The transmission rod (3b) is located at a central axis of the refrigerating cylinder (5).

In an embodiment of the present disclosure, the power output component (3a) is a motor. The motor is configured to drive the transmission rod (3b) and the stirring paddle (3c) to rotate. In a rotating process, the stirring paddle (3c) drives the milk to rotate, such that a part of the milk contacts the inner wall of the refrigerating cylinder (5) to form the ice cream more quickly. Meanwhile, in the forming process, air is charged to the milk for stirring, such that the ice cream is fluffier and more palatable.

Preferably, the refrigerating assembly (2) includes a condenser (2a), an evaporator tray (2b), a compressor (2c), and the heat exchange tube (2d).

One end of the heat exchange tube (2d) is connected to an inlet of the compressor (2c). An outlet of the compressor (2c) is connected to an inlet of the condenser (2a). An outlet of the condenser (2a) is connected to an inlet of the evaporator tray (2b). An outlet of the evaporator tray (2b) is connected to the other end of the heat exchange tube (2d).

A coiled tube evaporator is provided in the evaporator tray (2b). When the refrigerating cylinder (5) is to be cooled, low-temperature and low-pressure refrigerant gas in the heat exchange tube (2d) is charged to the refrigerating cylinder through the compressor (2c). Through compression, the temperature and the pressure of the refrigerant gas are increased, and conveyed to the condenser (2a). The condenser (2a) is configured to cool high-temperature and high-pressure refrigerant gas and convert it into a high-pressure liquid. The high-temperature liquid is then input to the coiled tube evaporator, such that the low-temperature and low-pressure liquid refrigerant is evaporated into refrigerant gas. The refrigerant gas is re-charged to the heat exchange tube (2d). The heat exchange tube (2d) is wound on an outer wall of the refrigerating cylinder (5). The refrigerating cylinder (5) is cooled by means of heat exchange.

Preferably, the cold beverage maker capable of measuring a temperature of a material further includes a loading tray (8). The loading tray (8) is located under the discharge assembly (4).

The loading tray (8) not only facilitates placement of a container for receiving the ice cream, but also can prevent the ice cream from falling onto a table.

In the description of this specification, the description with reference to the terms “an embodiment”, “some embodiments”, “an illustrative embodiment”, “an example”, “a specific example”, or “some examples” means that specific features, structures, materials or characteristics described with reference to the embodiment or example are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

Although the embodiments of the present disclosure have been illustrated and described, those of ordinary skill in the art can understand that various changes, modifications, replacements, and alterations may be made to these embodiments without departing from the principle and tenet of the present disclosure, and the scope of the present disclosure is defined by the claims and equivalents thereof.

1. A cold beverage maker capable of measuring a temperature of a material, comprising:
an electrical control assembly electrically connected to a refrigerating assembly (2) and a stirring assembly (3), and configured to control a working state of the refrigerating assembly (2) and a working state of the stirring assembly (3), and/or display a temperature of a material in a refrigerating cylinder (5);
a feed assembly (7) communicating with the refrigerating cylinder (5), and configured to convey the material to the refrigerating cylinder;
the refrigerating assembly (2) configured to refrigerate the refrigerating cylinder (5);
the stirring assembly (3) configured to stir the material in the refrigerating cylinder (5) to form a finished product and push the finished product to a discharge assembly (4); and
the discharge assembly (4) configured to discharge the finished product in the refrigerating cylinder, wherein
the cold beverage maker capable of measuring a temperature of a material further comprises a temperature sensor (6); the temperature sensor (6) comprises a sensing end (6a) and a connecting end (6b); the sensing end (6a) is provided in the refrigerating cylinder (5); and the sensing end (6a) is flush with an inner wall of the refrigerating cylinder (5); and
the connecting end (6b) is provided outside the refrigerating cylinder (5); and the connecting end (6b) is electrically connected to the electrical control assembly.

2. The cold beverage maker capable of measuring a temperature of a material according to claim 1, wherein the temperature sensor (6) is provided close to the discharge assembly (4).

3. The cold beverage maker capable of measuring a temperature of a material according to claim 1, wherein there are at least two temperature sensors (6), comprising a first temperature sensor (6c) and a second temperature sensor (6d); the first temperature sensor (6c) is provided close to the discharge assembly (4); and the second temperature sensor (6d) is provided close to the feed assembly (7); and
both the first temperature sensor (6c) and the second temperature sensor (6d) are electrically connected to the refrigerating assembly (2); and the first temperature sensor (6c) is further electrically connected to the electrical control assembly (9).

4. The cold beverage maker capable of measuring a temperature of a material according to claim 3, wherein both the first temperature sensor (6c) and the second temperature sensor (6d) are electrically connected to the stirring assembly (3).

5. The cold beverage maker capable of measuring a temperature of a material according to claim 3, wherein with a central axis of the refrigerating cylinder (5) as a standard line, a horizontal height of the second temperature sensor (6d) is not greater than a horizontal height of the standard line.

6. The cold beverage maker capable of measuring a temperature of a material according to claim 1, wherein the stirring assembly (3) comprises a power output component (3a), a transmission rod (3b), and a stirring paddle (3c); the power output component (3a) is provided at one side of a housing (1); the transmission rod (3b) comprises one end provided in the refrigerating cylinder (5) through a bearing, and the other end connected to the power output component (3a); a plurality of stirring paddles are equidistantly provided on a surface of the transmission rod (3b); and the transmission rod (3b) is located at a central axis of the refrigerating cylinder (5).

7. The cold beverage maker capable of measuring a temperature of a material according to claim 1, wherein the refrigerating assembly (2) comprises a condenser (2a), an evaporator tray (2b), a compressor (2c), and a heat exchange tube (2d); and
one end of the heat exchange tube (2d) is connected to an inlet of the compressor (2c); an outlet of the compressor (2c) is connected to an inlet of the condenser (2a); an outlet of the condenser (2a) is connected to an inlet of the evaporator tray (2b); and an outlet of the evaporator tray (2b) is connected to the other end of the heat exchange tube (2d).

8. The cold beverage maker capable of measuring a temperature of a material according to claim 1, further comprising a loading tray (8), wherein the loading tray (8) is located under the discharge assembly (4).

9. The cold beverage maker capable of measuring a temperature of a material according to claim 1, wherein the cold beverage maker is an ice cream maker or a smoothie maker.
